(19) United States
(12) Patent Application Publication
(10) Pub. No.: US 2006/0049372 A1
(43) Pub. Date: Mar. 9, 2006

(54) Valve assembly for water storage bladder

(76) Inventor: Chien-Ping Lien, Taipei Hsien (TW)

Correspondence Address: BACON & THOMAS, PLLC, 625 SLATERS LANE, FOURTH FLOOR, ALEXANDRIA, VA, 22314, US

(21) Appl. No.: 11/191,037

(22) Filed: Jul. 28, 2005

(30) Foreign Application Priority Data
Sep. 8, 2004 (TW) 093213349

(51) Int. Cl. F16K 7/04

(52) U.S. Cl. 251/7

(57) ABSTRACT

A water storage bladder includes a bladder and a valve assembly is connected to a bottom end of the bladder. The valve assembly includes a tubular member which is fixed to the bladder and has a threaded inner periphery which is threadedly connected with a connector. The connector has a fitting end extending therefrom so as to be connected with a hose. When the hose is removed from the connector, a cap is threadedly connected to the tubular member to seal the valve assembly.

### FIELD OF THE INVENTION

The present invention relates to a valve assembly for a water storage bladder and the valve assembly can be connected with a hose or sealed by a cap.

### BACKGROUND OF THE INVENTION

A conventional water storage bladder is shown in FIG. 1 and generally includes a soft bladder 1 with a valve 20 extends from a side of the bladder 1 and a hose 4 is connected to the valve 20 so that users may have the water in the bladder 1 by the valve 20. It is noted that the valve 20 is made by stiff material and protrudes from the outside of the bladder 1 so that it might tangled with objects. When the valve 20 is pulled, the connection portion between the bladder 1 and the valve 20 might be torn and water leaks from the connection portion of the valve 20 and the bladder 1. The valve 20 is located at a distance above the bottom end of the bladder 1 so that the water cannot completely flow out from the bladder 1 via the valve 20 and the hose 4. Furthermore, the hose 4 is fixed to the valve 20 so that when the bladder 1 is simply used as water storage, the hose 4 is inconvenient for carriage.

The present invention intends to provide a valve for a water storage bladder and a hose can be easily connected to the valve. The valve can also be easily sealed by a cap when the hose is not in use.

### SUMMARY OF THE INVENTION

The present invention relates to a bladder with a valve assembly connected to a bottom end of the bladder. The valve assembly includes a tubular member which has two lugs connected to the bottom end of the bladder and has a through passage which communicates with an interior of the bladder. The tubular member has a threaded inner periphery. A connector has an axial hole and a first threaded outer periphery is defined in a first end of the connector. The first threaded outer periphery of the connector is engaged with the threaded inner periphery of the tubular member. A fitting end extends from a second end of the connector so as to be connected with a hose.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of a water storage bladder with a conventional valve and a hose;

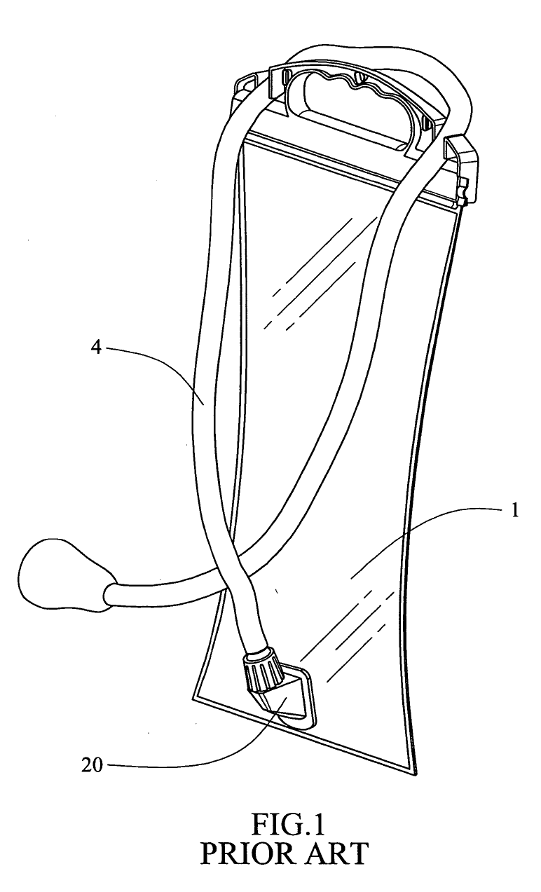

FIG. 2 is an exploded view to show the valve assembly of the present invention;

FIG. 3 is a cross sectional view of the valve assembly connected to the bladder and a hose is connected to the valve assembly, and

FIG. 4 shows that a cap seals the valve assembly.

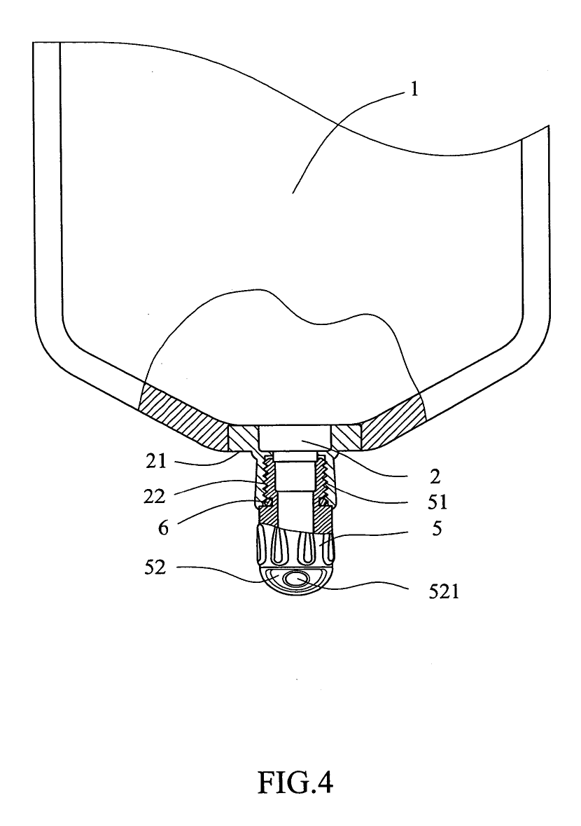

### DETAILED DESCRIPTION OF THE PREFERRED EMBODIMENT

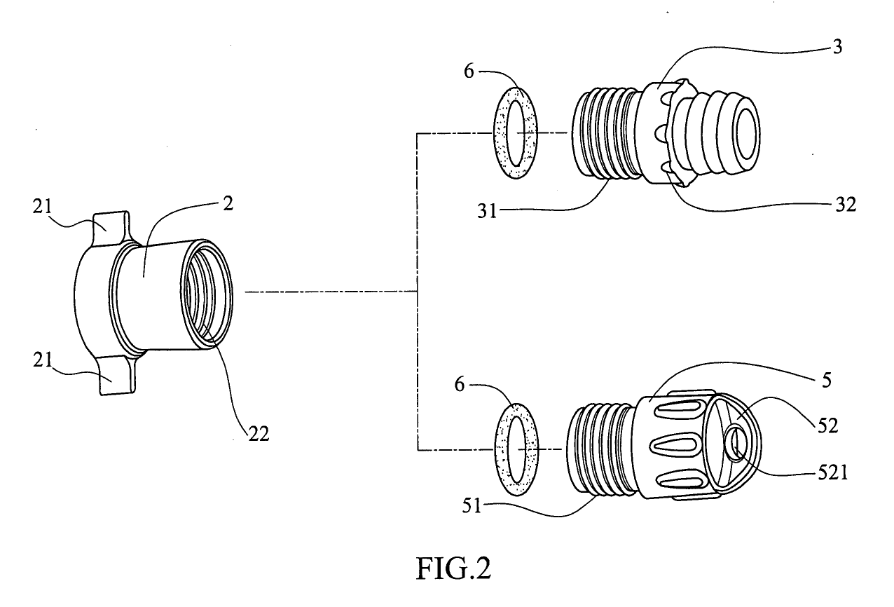

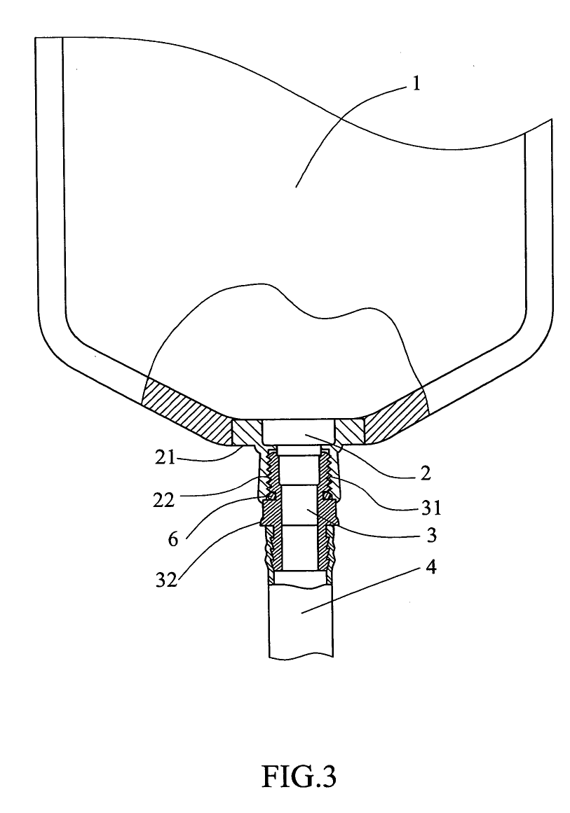

Referring to FIGS. 2 and 3, the valve assembly for a water storage bladder 1 of the present invention is connected to a bottom end of the bladder 1 and includes a tubular member 2 which has two lugs 21 which are enclosed by the bottom end of the bladder so as to fix the tubular member 2 with the bladder 1. The tubular member 2 has a through passage which communicates with an interior of the bladder 1 and has a threaded inner periphery 22. A connector 3 has an axial hole which is in communication with the tubular member 2 and a first threaded outer periphery 31 is defined in a first end of the connector 3. The first threaded outer periphery 31 of the connector 3 is engaged with the threaded inner periphery 22 of the tubular member 2. A seal 6 is mounted to the connector 3 and prevents water from leakage between the tubular member 2 and the connector 3. A fitting end extends from a second end of the connector 3 so as to be connected with a hose 4. The connector 3 has anti-slip members 32 protruding from an outside thereof so as to provide a good grasp when rotating the connector 3.

It is noted that the tubular member 2 is located at the lowest position of the bladder 1 so that the water in the bladder 1 can completely flow out from the valve assembly.

When the hose 4 is not in use, the hose 4 and the connector 3 can be easily removed from the connector 3 and a cap 5 is used to seal the tubular member 2. The cap 5 includes a second threaded outer periphery 51 defined in a first end thereof so as to be engaged with the threaded inner periphery 22 of the tubular member 2 to seal the tubular member 2. Another seal 6 is mounted to the cap 5 so as to prevent water from leakage between the tubular member 2 and the cap 5. The cap 5 further includes an operation handle 52 extending from a second end thereof for convenience of rotating the cap 5 to the tubular member 2. The operation handle 52 further includes a hole 521 for connected with a rope.

While we have shown and described the embodiment in accordance with the present invention, it should be clear to those skilled in the art that further embodiments may be made without departing from the scope of the present invention.

What is claimed is:

1. A water storage bladder comprising:
a bladder, and
a valve assembly connected to a bottom end of the bladder and includes a tubular member which has a through passage communicating with an interior of the bladder, the tubular member including two lugs connected with the bladder and has a threaded inner periphery, a connector having an axial hole and a first threaded outer periphery defined in a first end of the connector, a fitting end extending from a second end of the connector so as to be adapted to be connected with a hose, the first threaded outer periphery of the connector being engaged with the threaded inner periphery of the tubular member.

2. The bladder as claimed in claim 1, wherein the two lugs of the tubular member are enclosed by the lower end of the bladder.

3. The bladder as claimed in claim 1, wherein the connector has anti-slip members on an outside thereof.

4. The bladder as claimed in claim 1 further comprising a cap which includes a second threaded outer periphery defined in a first end thereof, the second threaded outer periphery is engaged with the threaded inner periphery of the tubular member.

5. The bladder as claimed in claim 4, wherein the cap includes an operation handle extending from a second end thereof.

6. The bladder as claimed in claim 5, wherein the operation handle includes a hole.
